(19) United States
(12) Patent Application Publication
(10) Pub. No.: US 2010/0052206 A1
(43) Pub. Date: Mar. 4, 2010

(54) Extrusion Mixing Screw And Method Of Use

(76) Inventors: Christopher Lane Kerr, Tioga, PA (US); Christopher John Malarkey, Corning, NY (US); Pascale Oram, Corning, NY (US); Watson Lewis Robbins, Watkins Glen, NY (US); Kenneth Charles Sariego, Beaver Dams, NY (US); David Robertson Treacy, JR., Horseheads, NY (US)

Correspondence Address: CORNING INCORPORATED, SP-TI-3-1, CORNING, NY, 14831, US

(21) Appl. No.: 12/548,906

(22) Filed: Aug. 27, 2009

Related U.S. Application Data
(60) Provisional application No. 61/093,016, filed on Aug. 29, 2008.

(51) Int. Cl. B29C 47/44

(52) U.S. Cl. 264/211.11; 425/205

(57) ABSTRACT

A twin-screw extruder includes a barrel including a pair of chambers in communication with each other and a discharge port, and an extrusion molding die coupled with respect to the discharge port of the barrel. First and second screw sets are rotatably mounted at least partially within respective ones of the pair of chambers. The first and second screw sets each include a raker blade segment at the discharge port of the barrel that includes at least one flight element with a plurality of serrations extending therethrough. Each of the first and second screw sets also include a lobed kneading segment at the discharge port of the barrel that includes at least one flight element. One of the raker blade segment and the lobed kneading segment is located downstream from another of the raker blade segment and lobed kneading segment. A method of using the twin-screw extruder is also provided.

### CROSS-REFERENCE TO RELATED APPLICATION

This application claims the benefit of priority to U.S. Application No. 61/093,016, filed on Aug. 29, 2008.

### TECHNICAL FIELD

The present invention relates generally to an apparatus for preparation of an extruded body, and more particularly, to preparation of a body comprised of ceramic, ceramic-forming material, or other highly filled material.

### BACKGROUND

Known methods and apparatus to provide a batch material for extruding the batch material into an extruded body can result in undesirable variations in temperature, shear, and/or composition constituent gradients. In various examples, the batch material can be extruded through a die to form a honeycomb body, or other thin-wall body.

### SUMMARY

In one aspect, a twin-screw extruder is provided for extruding a ceramic or ceramic-forming material. The extruder includes a barrel with a pair of chambers formed therein in communication with each other and a discharge port. An extrusion molding die is coupled with respect to the discharge port of the barrel. A first screw set is rotatably mounted at least partially within one of the pair of chambers and includes a first drive shaft. A second screw set is rotatably mounted in the other of the pair of chambers and includes a second drive shaft generally parallel to the first drive shaft. The first and second screw sets each include a raker blade segment removably coupled to a respective one of the first and second drive shafts at the discharge port of the barrel, wherein each raker blade segment includes a double-flight element with a plurality of serrations extending through each of the flight elements. The first and second screw sets each further include a trilobe kneading segment removably coupled to a respective one of the first and second drive shafts at the discharge port of the barrel, wherein the trilobe kneading element includes a triple-flight element. One of the raker blade segment and the trilobe kneading segment is located at an end of the respective screw set and adjacent the extrusion molding die, and downstream of the other of the raker blade segment and the trilobe kneading segment.

In another aspect, a twin-screw extruder is provided. The extruder includes a barrel with a pair of chambers formed therein in communication with each other and a discharge port. An extrusion molding die is coupled with respect to the discharge port of the barrel. A first screw set is rotatably mounted at least partially within one of the pair of chambers, and a second screw set is rotatably mounted at least partially within the other of the pair of chambers. The first and second screw set each includes a raker blade segment at the discharge port of the barrel, wherein each raker blade segment includes at least one flight element with a plurality of serrations extending through each flight element. The first and second screw set each further includes a lobed kneading segment at the discharge port of the barrel, wherein each lobed kneading segment includes at least one flight element. Each lobed kneading segment is located upstream from the corresponding raker blade segment.

In yet another aspect, a method of using a twin-screw extruder for preparing a batch material to produce an extruded thin-wall body is provided. The method includes the step of providing a barrel including a pair of chambers formed therein in communication with each other. The barrel includes a discharge port and an extrusion molding die coupled with respect to the discharge port of the barrel. The method further includes the steps of providing a first screw set rotatably mounted at least partially within one of the pair of chambers, and providing a second screw set rotatably mounted at least partially within the other of the pair of chambers. The method further includes the step of providing a flowable ceramic batch material into the barrel. The method further includes the steps of mixing the ceramic batch material circumferentially between the pair of chambers at the discharge port of the barrel, and mixing the ceramic batch material axially within each of the pair of chambers at the discharge port of the barrel. The method further includes the step of extruding the ceramic batch material through the extrusion die to produce the ceramic honeycomb green body.

It is to be understood that both the foregoing general description and the following detailed description present example and explanatory embodiments of the invention, and are intended to provide an overview or framework for understanding the nature and character of the invention as it is claimed. The accompanying drawings are included to provide a further understanding of the invention and are incorporated into and constitute a part of this specification. The drawings illustrate various example embodiments of the invention, and together with the description, serve to explain the principles and operations of the invention.

### BRIEF DESCRIPTION OF THE DRAWINGS

These and other features, aspects and advantages of the present invention are better understood when the following detailed description of the invention is read with reference to the accompanying drawings, in which:

FIG. 1 is a schematic view of an example twin-screw extruder in accordance with aspects of the present invention;

FIG. 2 is a front sectional schematic view taken along line 2-2 of FIG. 1 illustrating an example screw segment in accordance with other aspects of the present invention;

FIG. 3 is a perspective view of the screw segment of FIG. 2;

FIG. 4A is a partial schematic view of an example pumping channel of the example screw segment of FIG. 3;

FIG. 4B is a partial schematic view of another example pumping channel of the example screw segment of FIG. 3;

FIG. 4C is a partial schematic view of yet another example pumping channel of the example screw segment of FIG. 3;

FIG. 5 is a perspective view of another example screw segment in accordance with other aspects of the present invention;

FIG. 6 is a side view of the example screw segment of FIG. 5;

FIG. 7 is a front view of the example screw segment of FIG. 5;

FIG. 8 is a front schematic view of an example mixing segment in accordance with other aspects of the present invention;

FIG. 9 is a side sectional schematic view taken along line 9-9 of FIG. 8; and

FIG. 10 is a detail view of the example mixing segment of FIG. 8.

### DETAILED DESCRIPTION

The present invention will now be described more fully hereinafter with reference to the accompanying drawings in which example embodiments of the invention are shown. However, this invention may be embodied in many different forms and should not be construed as limited to the embodiments set forth herein. Like reference numbers refer to like elements throughout the various drawings.

Porous honeycomb articles are known to facilitate filtering of fluid to remove undesirable components. In one example, porous honeycomb articles are known to function as a particulate filter and may or may not include a catalyst layer. Such porous honeycomb filters are useful, for example, to filter exhaust from an engine (e.g., diesel engine) before releasing the exhaust to the environment. Other examples of porous honeycomb articles can include flow-through substrates or other thin-wall bodies.

Porous honeycomb articles can comprise various materials depending on the particular application and substrate characteristics. For instance, the porous honeycomb articles can comprise cordierite, aluminum titanate, silicon carbide, mullite or other materials. In one example, porous cordierite ceramic honeycomb articles can be formed with a wide variety of batch compositions including a quantity of inorganic components. The quantity of inorganic components can include oxide sources of magnesia, alumina and silica effective to form cordierite (Mg₂Al₄Si₅O₁₈) upon firing. Such oxide sources can be provided, for example, by talc, alumina, aluminum hydroxides, clay, and/or silica.

Various ceramic honeycomb articles may be produced with the concepts of the present invention. For example, honeycomb articles can be formed with a honeycomb structure disclosed in U.S. Pat. No. 6,562,284 to Beall et al. that is herein incorporated by reference in its entirety. In one example, the honeycomb articles of the present invention can include cell geometries with a cell density of greater than 200 cells/in² (cpsi). In further examples, honeycomb articles of the present invention can include cell geometries with a cell density of greater than about 300 cpsi, such as greater than about 400 cpsi, 500 cpsi, 600 cpsi, 700 cpsi, 800 cpsi, or 900 cpsi. Furthermore, the walls forming the cells are porous and can have a wall thickness of less than 12 mil (305 μm), or even less than or equal to 1 mil (25.4 um).

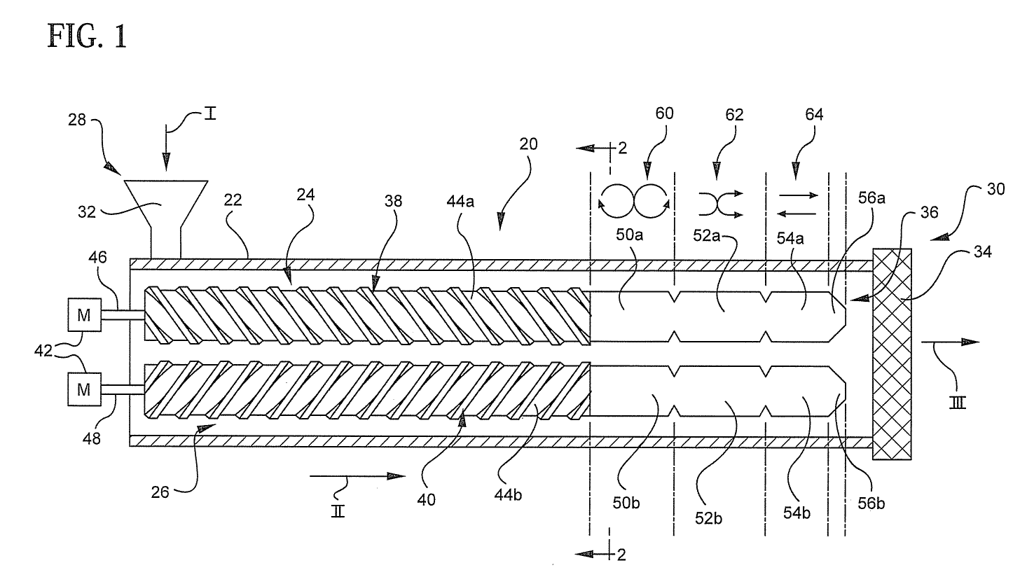

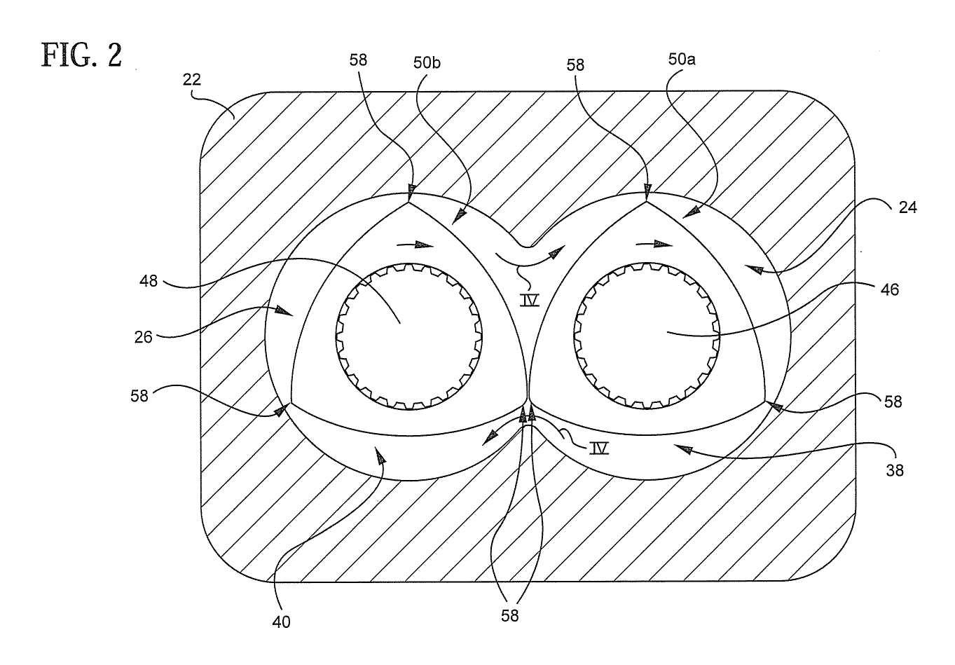

Turning to the example shown in FIG. 1, an example continuous twin-screw extruder 20 is schematically illustrated. The twin-screw extruder 20 includes a barrel 22 including a pair of chambers 24, 26 formed therein and in communication with each other (see also FIG. 2). The barrel 22 can be monolithic, or can be formed from a plurality of barrel segments connected successively in the longitudinal (i.e., axial) direction. The chambers 24, 26 penetrate the barrel 22 in the longitudinal direction from an upstream side 28 to a downstream side 30. At the upstream side 28 of the barrel 22, a material supply port 32, which can include a hopper or other material supply structure, is provided for supplying the batch material to the extruder 20. An extrusion die 34 is provided at a discharge port 36 at the downstream side 30 of the barrel 22 for extruding the batch material into a desired shape, such as honeycomb article or the like. The extrusion die 34 can be coupled with respect to the discharge port 36 of the barrel 22, such as at an end of the barrel 22. The extrusion die 34 can be preceded by other structure, such as a generally open cavity (not shown), screen/homogenizer (not shown), or the like to facilitate the formation of a steady plug-type flow front before the batch reaches the extrusion die 34.

The extruder 20 can include various additional features. In one example, the extruder 20 can include a second supply port (not shown) at an intermediate portion of the barrel 22 for supplying additional batch material, additives, etc. to be processed by the extruder 20. In another example, the barrel 22 can include open vents (not shown) in communication with the chambers 24, 26 for degassing, and/or even a vacuum vent (not shown) for evacuating the chambers 24, 26 under vacuum. In addition or alternatively, a cooling pipe or the like (not shown) can be coupled to the barrel 22 for cooling, such as by cool water or the like, the batch material (not shown) being processed within the extruder 20. Still, the cooling pipe structure could alternatively be utilized to supply a hot medium, such as hot water or steam, to heat the batch material if desired.

A pair of extruder screw sets are mounted in the barrel 22. As shown, a first screw set 38 is rotatably mounted at least partially within one of the chambers 24, while a second screw set 40 is rotatably mounted at least partially within the other of the chambers 26. The first and second screw sets 38, 40 can be arranged generally parallel to each other, as shown, though they can also be arranged at various angles relative to each other. The first and second screw sets 38, 40 can also be coupled to a driving mechanism 42 outside of the barrel 22 for rotation in the same, or even different, directions. It is to be understood that the both of the first and second screw sets 38, 40 can be coupled to a single driving mechanism 42, or as shown, individual driving mechanisms 42.

Each of the first and second screw sets 38, 40 can include various segments extending along their longitudinal lengths, and each segment can impart various processes upon the batch located within the barrel 22. The first and second screw sets 38, 40 can be monolithic, having each of the segments formed with the screw sets 38, 40. Alternatively, as shown, each of the segments can be formed from a plurality of removable screw segments connected successively in the longitudinal (i.e., axial) direction (or even a combination of removable and non-removable segments). In one example, each of the first and second screw sets 38, 40 can include first and second drive shafts 46, 48, respectively, having a rotational axis generally aligned with the centers of the respective chambers 24, 26. The first and second drive shafts 46, 48 can have the plurality of screw segments removably coupled thereto in various manners. For example, the removable screw segments can be removably coupled via a spline shaft, keyway structure, set screws, etc. Still, any or all of the removable screw segments can be non-removably coupled to the drive shafts 46, 48, such as by adhesives, welding, etc.

The plurality of screw segments can include various types. For clarity, it is to be understood that similar, such as identical, screw segments of each of the first and second screw sets 38, 40 will have similar reference numbers with respective “a” or “b” designations, with the understanding that any descriptions can apply to both such similar segments. In one example, a pumping screw segment 44a, 44b can be arranged generally towards the upstream side 28 of the extruder 20 for feeding the batch material from the supply port 32 and pumping or pushing the batch material towards the downstream side 30. The pumping screw segments 44a, 44b can include various single-flight or multi-flight spiral designs, as desired. Each of the pumping screw segments 44a, 44b can be of the meshing type having flights arranged so as to mesh with each other inside the barrel 22. For example, during rotation, one of the pumping screw segments 44a can scrape material off the other pumping screw segments 44b.

The ceramic batch material processed by the twin-screw extruder 20 (e.g., such as the cordierite batches) can be sensitive to the amount of shear mixing and/or temperature fluctuations that occurs inside the extruder 20, which can result in differential flows causing various internal defects at the exit of the extrusion die 34. Moreover, undesirable patterns and/or defects can be created in the cell walls of a honeycomb extrusion as a result of patterns in rheology of the batch slug that feeds the extrusion die 34. Such patterns can be impacted by mixing or shear stress distributions imparted to the batch from the twin-screw mixing and pumping of the twin-screw extruder 20. The patterns can also be impacted by temperature variations caused by the twin-screw mixing and/or the cooling system coupled to the barrel 22, such as a relatively hotter center batch and a relatively cooler skin. In various examples, the undesirable patterns and/or defects can include “swirl” patterns which result from the discharge of the batch from the screws 44a, 44b during each revolution, and/or swollen webs that buckle or become “wiggly” in the direction of flow. In addition or alternatively, other possible undesirable patterns and/or defects can include internal tearing, auger spots, and/or fast-flow webs

As a result, it can be beneficial to provide different screw segments located towards the downstream side 30 of the barrel 22 and near the discharge port 36 to promote a relatively more uniformly mixed and discharged batch material to reduce temperature, shear, and/or composition constituent gradients at the extruder outlet. As will be discussed more fully herein, the different screw segments located towards the downstream side 30 of the barrel 22 can provide efficient pumping of the ceramic batch material under relatively high pressures (e.g., 1,000-5,000 psi) while reducing, such as minimizing, energy input and while promoting relatively more uniform dispersive and distributive mixing. In addition or alternatively, the operating pressure can be reduced, the overall temperature can be reduced, and/or the temperature fluctuations can be reduced.

Various types and configurations of different screw segments 50, 52, 54, 56 can be located towards the downstream side 30 of the barrel 22 at the discharge port 36 to promote a relatively more uniformly mixed and discharged batch material. It is to be understood that the phrase “at the discharge port 36” is intended to refer to a location near the downstream side 30 of the barrel 22 and the extrusion die 34. The location may be immediately adjacent the extrusion die 34, or may be spaced a distance therefrom, such as a distance of one or more screw segments. In other words, the location may include any of the illustrated screw segments 50, 52, 54, 56, and is generally intended to be closer to the downstream side 30 than the upstream side 28. The types, numbers, and configurations of screw segments can facilitate various types of batch material mixing, such as circumferential mixing (i.e., mixing of the ceramic batch between the pair of chambers 24, 26 of the barrel 22), axial mixing (i.e., mixing of the ceramic batch along the longitudinal axis within each of the pair of chambers 24, 26 of the barrel 22), and/or radial mixing (i.e., mixing a radially-inward portion of the ceramic batch with a radially-outward portion of the ceramic batch). Each type of mixing is illustrated in FIG. 1 with a schematic symbol: circumferential mixing 60; radial mixing 62; and axial mixing 64. Although illustrated in FIG. 1 in one example order, it is to be understood that the various segments 50, 52, 54 can be arranged variously.

Turning now to FIGS. 1-3, one screw segment 50a, 50b can include a lobed kneading segment that can facilitate circumferential mixing 60 of the batch material along the direction of arrow IV in FIG. 2 (i.e., mixing of the ceramic batch material between the pair of chambers 24, 26 of the barrel 22). The rotational centers of the lobed kneading segments can be aligned with the associated chamber 24, 26 of the barrel 22. The lobed kneading segment 50a, 50b can include at least one flight element. In one example (not shown), the lobed kneading segment can be a bilobe kneading segment that includes a double flight element. In another example, as shown, the lobed kneading segment can be a trilobe kneading segment 50a, 50b that includes a triple-flight element 58. The triple flight elements 58 can be arranged at generally equal angular intervals of about 120 degrees in the circumferential direction. Each of the flight elements 58 can be spirally formed about the length of the kneading segment 50a, 50b. The three lobes of the trilobe design can provide three pumping channels to provide increased frequency and a smaller volume of material pumped per flight to thereby reduce the degree of segregation that can otherwise lead to shear and/or temperature gradients.

The trilobe kneading segment 50a, 50b can include various additional features to facilitate the circumferential mixing 60. In one example, a smooth curvilinear section 66 can promote movement of the batch material over the various flights 58 to promote the circumferential mixing 60 between the chambers 24, 26. For example, the smooth curvilinear section 66 can reduce the distance between the center batch material and the barrel wall to facilitate an increase in heat extraction from the batch material (i.e., via the cooling system coupled to the barrel 22). The smooth curvilinear section 66 can have various dimensions, such as about 0.6D or greater, wherein D is an inner diameter of the corresponding chamber 24, 26 of the barrel 22. For example, the smooth curvilinear section 66 can be approximately 120 mm for a 177 mm inner chamber diameter, though various other dimensions and/or ratios are contemplated. In another example, the trilobe kneading segment 50a, 50b can have a relatively large element to barrel clearance, and relatively large area reduction to enable contraction of the batch material over the flight elements 58 to facilitate dispersive mixing, and contact against the barrel wall for cooling. In one example, the area reduction ratio from the root to the crest of the flights 58 can be approximately two to one (2:1) or even four to one (4:1), though other area reduction ratios are also contemplated. For example, an area reduction ratio that compares a first area between a root of the flights of the trilobe kneading segment and the barrel wall, and a second area between a crest of the flights of the trilobe kneading segment and the barrel wall, can be approximately two to one (2:1).

In another example, the flights 58 can have a relatively high pitch to provide a relatively low pumping efficiency and a relatively high degree of mixing that provides increased over-flight leakage to promote the dispersive shearing and circumferential mixing 60. In one example, at least one flight element of the trilobe kneading element can include a pitch P that is equal to or greater than 3D, or even equal to or greater than 10D, wherein D is an inner diameter of the corresponding chamber 24, 26 of the barrel 22. For example, where the inner diameter D of a corresponding chamber 24 is about 90 millimeters, the pitch P can be equal to or greater than about 900 millimeters (i.e., 10 times 90 mm). In other examples, the trilobe kneading element can include a pitch P that is equal to or greater than 15D (i.e., 1350 mm) or even 20D (i.e., 1800 mm). In the example shown, the trilobe kneading element includes a pitch P of about 1440 mm, or about 16D.

The relatively high pitch can provide a relatively low pumping efficiency. In one example, the relatively high pitch can provide a pumping efficiency equal to or less than about 10%. In another example, such as where the pitch P is about 1440 mm (i.e., about 16D), the relatively high pitch can provide a pumping efficiency equal to or less than about 3%, or even equal to or less than about 2%, which should permit about 98% of the batch material to experience similar amounts of shear history. Similarly, the relatively high pitch can provide a slightly positive pumping action to inhibit, such as prevent, undesirable pressure losses through use of the trilobe section.

However, because the ceramic batch material being processed by the trilobe kneading segment 50a, 50b can have a relatively high stiffness, the low efficiency of the circumferential mixing can cause a relatively large amount of heat and/or thermal gradients. Thus, it can be beneficial to limit the mixing length L (i.e., in the axial direction) of the trilobe kneading segment 50a, 50b. In one example, at least one flight element 58 of the trilobe kneading segment 50a, 50b can extend axially a distance generally equal to or less than about P/10 (i.e., the pitch P divided by 10). For example, where the pitch P is about 1440 mm, the axial length L of the trilobe kneading segment 50a, 50b can be equal to or less than about 144 mm (i.e., 1440 divided by 10). In another example, where the pitch is about 1440 mm, the axial length L of the trilobe kneading segment 50a, 50b can be equal to or less than about P/12, or about 120 mm. Still, the trilobe section can have various other axial lengths, such as equal to or less than about P/1, P/2, P/4, or P/5.

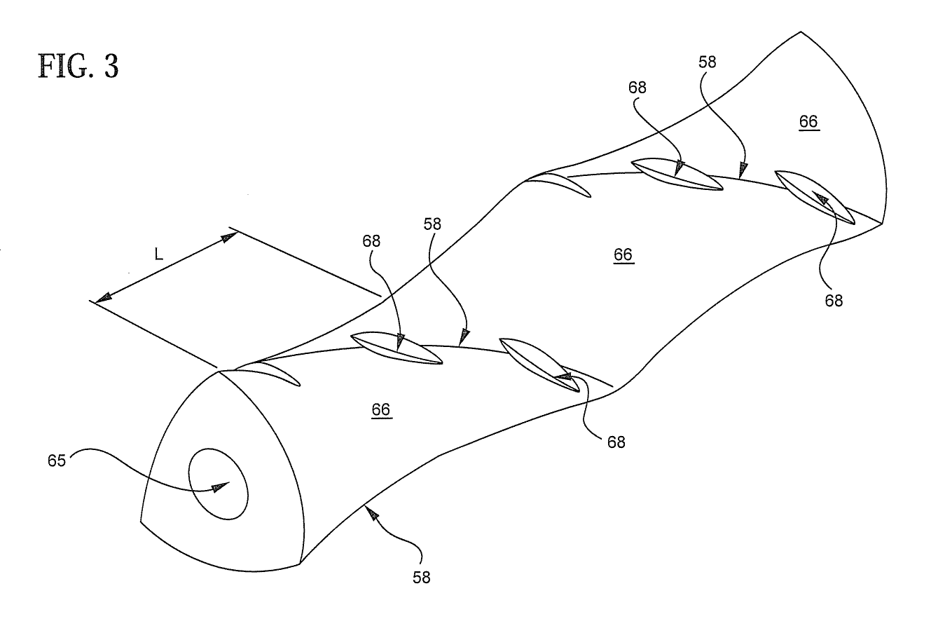

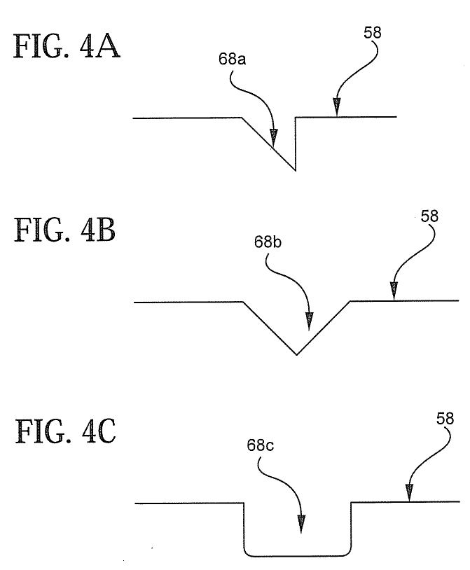

The lobed kneading segment 50a, 50b can also include various other features. For example, as shown in FIG. 3, a hole 65 can be provided generally about the rotational axis and can extend through the length thereof to provide an interface with the drive shaft 46, 48 of a screw set 38, 40. The hole 65 can include structure adapted to interface with the associated structure (e.g., spline shaft, keyway structure, set screws, etc.) of the drive shaft 46, 48. In addition or alternatively, the various flight elements 58 can include one or more positive pumping channels to provide a more positive pumping action, and/or a degree of axial mixing. The positive pumping channels 68 can be configured as slots or the like that cut across and extend a distance into each of the flight elements 58. The positive pumping channels 68 can be oriented generally perpendicular to the flight elements 58, or as shown, can extend across the flight elements 58 at an angle, such as a generally forward angle to provide a more positive pumping action. In one example, all of a plurality of the positive pumping channels can extend into the trilobe kneading segment to approximately the same depth. In another example, a first portion of the plurality of positive pumping channels extend into the trilobe kneading segment to a first depth, and wherein a second portion of the plurality of positive pumping channels extend into the trilobe kneading segment to a second depth (i.e., variable depth notches). In addition or alternatively, the plurality of positive pumping channels can be generally uniformly spaced about the trilobe kneading segment, or alternatively, can be variably spaced thereabout (i.e., uniform or variable density, etc.). Moreover, as shown in FIGS. 4A-4C, the positive pumping channels 68 can include various cross-sectional geometries for affecting the flow of the batch material. For example, as shown in FIG. 4A, the positive pumping channels 68a can include a forward-facing angle to provide a relatively greater positive pumping action. In other examples, as shown in FIG. 4B-4C, the positive pumping channels 68b, 68c, respectively, can include a centered angle geometry to provide a reduced positive pumping action (or even alternating forward and backward flow), or even a squared-geometry to provide an even further reduced positive pumping action. Still, various other geometries are also contemplated.

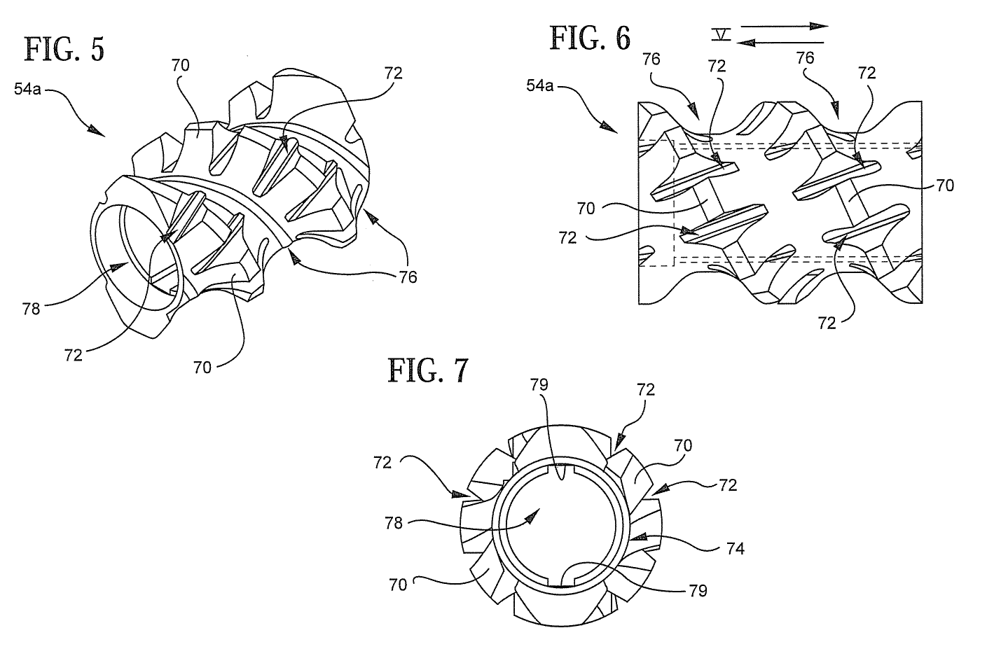

Turning now to FIGS. 5-7, another screw segment 54a, 54b can include a raker blade segment that can facilitate axial mixing 64 of the batch material along the direction of arrows V in FIG. 6 (i.e., mixing of the ceramic batch material axially within each of the chambers 24, 26 of the barrel 22). The rotational centers of the raker blade segments can be aligned with the associated chamber 24, 26 of the barrel 22. A hole 78 can be provided generally about the rotational axis and can extend through the length thereof to provide an interface with the drive shaft 46, 48 of a screw set 38, 40. The hole 78 can include structure 73 adapted to interface with the associated structure (e.g., spline shaft, keyway structure, set screws, etc.) of the drive shaft 46, 48.

The raker blade segments 54a, 54b can include at least one flight element. In another example, as shown, the raker blade segment can be a bilobe segment that includes a double flight element 70. In other examples (not shown), the raker blade segment can include three or more flight elements. The double flight elements 70 can be arranged at generally equal angular intervals of about 180 degrees in the circumferential direction. Each of the flight elements 70 can be spirally formed about the length of the raker blade segment 54a, 54b. Thus, the spiral flight elements 70 can provide a positive pumping action for the batch material. The two lobes of the double flight design can provide two pumping channels to provide increased frequency of material pumped per flight to thereby reduce the degree of segregation that can otherwise lead to shear and/or temperature gradients.

Each flight segment 70 of the raker blade segment 54a, 54b can include a plurality of serrations 72 extending therethrough that can be configured as slots or the like that cut across and extend a distance into each of the flight elements 70. As shown in FIGS. 5-6, a relatively large number of serrations 72 can extend through each flight segment 70 to provide a relatively aggressive axial mixing of the batch material. The plurality of serrations 72 can be similar or different. For example, some or all of the serrations 72 can extend substantially to a root 74 of the corresponding raker blade segment 54a, 54b. As a result, the “deep” serrations 72 can provide a relatively increased axial mixing of the radially inward batch material with the radially outward batch material. Still, some or all of the serrations may extend only partially through the flight 70 towards the root, such as about half-way or even other distances. In addition or alternatively, the axial mixing provided by the serrations 72 can be influenced by a ratio of the width and height of the serrations 72 as compared to the width and height of the flight segments 70, or even the density of the serrations 72 extending through the flight segments 70. For example, relatively increasing the flight/crest section by a factor of 2, as compared to the serrations 72 (i.e., a 2:1 ratio), can permit about twice (2×) the amount of batch material to be pumped forwardly while permitting maintaining a constant (1×) amount of batch material to be pushed through the serrations 72. Similarly, increasing the density of the serrations 72 while maintaining the flight segments 70 the same can permit relatively more of the batch material to be pushed through the serrations 72. In short, it is to be understood that various combinations of geometries, spacing, densities, etc. of the flight segments 70 and the serrations 72 can permit different amounts of the batch material to be pumped therethrough, respectively.

In addition or alternatively, as shown, the serrations 72 can be oriented generally perpendicular to the flight elements 58. Alternatively (not shown), some or all of the serrations 72 can extend across the flight elements 70 at an angle, such as a generally forward angle to provide a more positive pumping action. For example, the plurality of serrations 72 can be oriented at a forward angle equal to or greater than about 30 degrees relative to a respective flight element 58, though various other angles are also contemplated. Moreover, the serrations 72 can include various cross-sectional geometries for affecting the flow of the batch material. For example, as shown in FIG. 7, the serrations 72 can include a centered angle geometry (i.e., a “V” geometry) or even a flattened centered angle geometry (i.e., a “U” geometry) to provide an alternating forward and backward flow and/or a reduced positive pumping action. In other examples (not shown), the serrations 72 can include a forward-facing angle to provide a relatively greater positive pumping action, or even a squared-geometry to provide a reduced positive pumping action. Still, various other geometries are also contemplated.

In addition or alternatively, the flights 70 can have a relatively high pitch to provide a relatively high degree of axial mixing 64 to promote dispersive shearing. In one example, at least one flight element of the bilobe raker blade element 54a, 54b can include a pitch P that is equal to or greater than about 0.5D, or equal to or greater than about 2D, or even equal to or greater than about 4D, wherein D is an inner diameter of the corresponding chamber 24, 26 of the barrel 22. For example, where the inner diameter D of a corresponding chamber 24 is about 170 millimeters, the pitch P can be equal to or greater than about 250 millimeters (i.e., 1.5D or 1.5 times 170 mm). In other examples, the trilobe kneading element can include a pitch P that is equal to or greater than 1.2D (i.e., 205 mm), equal to or greater than 2D (i.e., 340 mm), or even equal to or greater than 4D (i.e., 680 mm). In the example shown, the trilobe kneading element includes a pitch P of about 244 mm, or about 1.4D. Thus, the relatively high pitch can also provide a plurality of pumping channels 76 therebetween.

In operation, rotation of the raker blade segment 54a, 54b within the chamber 24, 26 of the barrel 22 causes the batch material to be pumped downstream via the channels 76 between the spiral flights 70, while also relatively increasing the pressure level within the flow of batch material. A drag effect caused by an inner surface of the chamber 24, 26 of the barrel 22 can resist rotation of the batch material pumped by the rotating raker blade segment 54a, 54b, which can thereby induce a counter-flow of the batch material through the serrations 72 in an opposite direction. Thus, a portion of the batch material flows downstream via the channels 76 between the spiral flights 70, while another portion of the material flows upstream via the serrations 72 extending through the flights 70. As a result, the axial mixing 64 of the ceramic batch material is provided along the direction of arrows V in FIG. 6 by this continuous separation and recombining of the batch material.

Axial mixing of the batch material can provide several benefits. For example, axial mixing near the downstream side 30 at the discharge port 36 can reduce, such as eliminate, swirl or “shadow” defects and/or swollen webs. In other examples, axial mixing at the discharge port 36 can improve the squareness or orthogonality of the cellular structure of the extruded honeycomb ceramic part, and the rheology of the batch material can have improved uniformity. The life of the extrusion die 34 can also be increased because local “fast flow” areas may not be worn into the die causing premature die 34 failure and/or replacement. Moreover, because some or all of the defects can be reduced, feedrate of the batch material through the twin-screw extruder 20 can be relatively increased

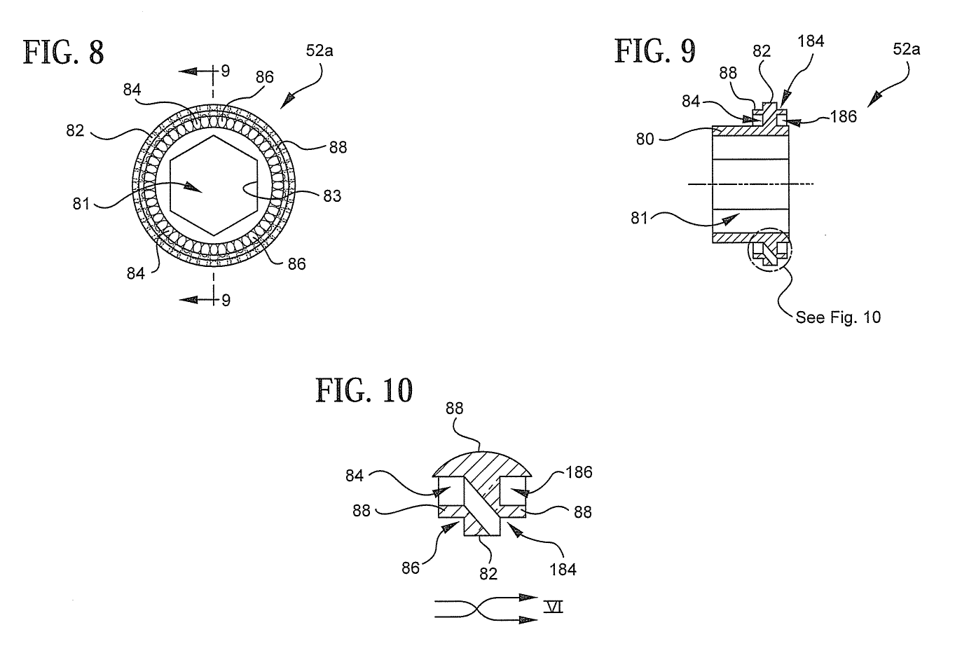

Turning now to FIGS. 8-10, yet another screw segment 52a, 52b can include a radial mixing element that can facilitate radial distributive mixing of the batch material along the direction of arrows VI in FIG. 9 (i.e., mixing a radially-inward portion of the ceramic batch with a radially-outward portion of the ceramic batch). For example, where cooling structure is coupled to a portion of the barrel 22, the radially outward portion of the batch material closest to the barrel 22 can have a relatively reduced temperature, while the radially inward portion of the batch material furthest from the barrel 22 can have a relatively increased temperature. Because the ceramic batch material can be a generally poor thermal conductor, and because it generally does not exhibit secondary swirling flows as found in plastics, the radial mixing element can facilitate the reduction of temperature gradients and provide for a more uniform batch.

The rotational center of the radial mixing segments can be aligned with the associated chamber 24, 26 of the barrel 22. A hole 81 can be provided generally about the rotational axis 85 and can extend through the length thereof to provide an interface with the drive shaft 46, 48 of a screw set 38, 40. The hole 81 can include structure 83 adapted to interface with the associated structure (e.g., spline shaft, keyway structure, set screws, etc.) of the drive shaft 46, 48. It is to be understood that the radial mixing element 52a, 52b can rotate together with the drive shafts 46, 48, which can reduce patterns in the batch material, or can remain stationary with rotation of the drive shafts 46, 48 via a rotational support, such as a bearing, bushing, or the like.

The radial mixing element 52a, 52b generally includes a central tube 80 having an annular ring 82 extending a distance outwards. The annular ring 82 generally defines a diameter equal to or slightly less than an interior diameter of an associated chamber 24, 26 so as to provide a “dam” to inhibit the batch material from passing thereby. The annular ring 82 further includes a plurality of inner holes 84 and outer holes 86 extending therethrough for capturing radially inner and outer portions, respectively, of the batch material. The inner and outer holes 84, 86 can each have a uniform cross-sectional area, or it may vary over the extent thereof. The inner and outer holes 84, 86 can each be arranged in a pattern, such as equally distributed arrays located about the annular ring 82. Moreover, as shown in FIG. 8, the arrays of inner and outer holes 84, 86 can be angularly offset and/or alternatively spaced about the annular ring 82 so as to provide sufficient spacing for each of the holes 84, 86 to extend therethrough. In addition or alternatively, a separator ring 88 can extend outwardly from either or both sides of the annular ring 82 for facilitating separation between the flow of batch material into or out of the inner and outer holes 84, 86.

As shown in FIG. 10, the inner and outer holes 84, 86 can extend through the annular ring 82 at an angle relative thereto. For example, the inner holes 84 can be angled upwards and towards a radially outward direction to the inner hole exit 184, while the outer holes 86 can be angled downwards and towards a radially inward direction to the outer hole exit 186. Thus, as the batch material is pumped downstream, a first, radially inward portion of the ceramic batch material is mixed and transposed with a second, radially outward portion of the ceramic batch material. Specifically, the first portion of the ceramic batch material that is the radially inward portion (i.e., radially located between the rotational axis 85 of the radial mixing element 52a, 52b and a second, radially outward portion of the ceramic batch material) can enter the inner holes 84 and be directed upwards at an angle and towards a radially outward position to be dispensed by the inner hole exits 184. Similarly and conversely, the second portion of the ceramic batch material that is the radially outward portion (i.e., radially located adjacent the walls of the chamber 24, 26 of the barrel 22) can enter the outer holes 86 and be directed downwards at an angle and towards a radially inward position to be dispensed by the outer hole exits 186. In short, as shown schematically with the arrows VI in FIG. 9, the first, radially inward portion of the ceramic batch material is switched with the second, radially outward portion of the ceramic batch material. As a result, the radial mixing can provide a reduction of temperature gradients and provide for a more uniform batch.

In addition or alternatively, any or all of the segments 50, 52, 54 discussed herein can be formed of various materials, coatings, and/or surface treatments in an effort to reduce, such as minimize, heat generation and/or segment wear. Generally, the energy required to extrude a material can be influenced by the batch material rheology and the frictional forces associated with different material surface finishes and/or chemistries. In one example, a tungsten carbide matrix material can begin life with a surface roughness of approximately 80 micro-inches Ra (i.e., 80 micro-inches (approx. 2 micro-meters) roughness utilizing the arithmetic average of absolute values scheme as determined by any known measuring technique and/or methodology, hereinafter “Ra”). However, the abrasive wear of the batch material being processed through the twin-screw extruder 20 can increase the surface roughness of the tungsten carbide matrix material to be 200 micro-inches Ra (approx. 5 micro-meters) or greater, which can increase the energy required due to increased frictional forces and/or heat generation. Moreover, the increased roughness can produce defects in the batch material, and/or non-uniform temperature, shear, and/or composition constituent gradients.

Thus, it can be beneficial to utilize relatively higher-wearing materials that can relatively reduce in surface roughness as a result of the abrasive wear of the batch material being processed, such as to a surface roughness, equal to or less than about 80 micro-inches Ra (approx. 2 micro-meter), or equal to or less than about 40 micro-inches Ra (approx. 1 micro-meter), or even equal to or less than about 30 micro-inches Ra (approx. 0.75 micro-meters). In one example, any or all of the segments 50, 52, 54 discussed herein can be formed with a tool steel, such as a D2 tool steel that may reduce in surface roughness to a polished, near-mirror surface of about 5 micro-inches Ra (approx. 0.125 micro-meters) roughness, though the wear rate may not be favorable from a manufacturing cost perspective. In another example, any or all of the segments 50, 52, 54 discussed herein can be formed with a powdered metal homogeneous material such a CPM-10V steel that can being with a surface roughness of about 20 micro-inches Ra (approx. 0.5 micro-meters) that may reduce in surface roughness to about 10 micro-inches Ra (approx. 0.125 micro-meters) during use. Though the CPM-10V material may or may not provide an extended wear life, it may generate less heat. For example, use of the CPM-10V material may reduce the extrusion batch material temperature by two to four degrees centigrade, which may permit the extrusion feedrate to be increased, such as by 10% or more. Still, other materials may be used, such as various ceramic, polymer, and/or polymer-filled systems that can provide acceptable wear. Additionally, it can be beneficial to utilize a material having a relatively high hardness rating with a surface finish that either stays about the same or improves (i.e., the surface roughness value decreases), or does not greatly increase. For example, it can be advantageous to utilize materials having a hardness rating of approximately 50-70 Rockwell C or equivalents thereto, though various other hardness ratings can also be utilized.

Turning briefly back to FIG. 1, it is to be understood that the various mixing segments 50, 52, 54 discussed herein can be arranged in various orders to promoting relatively more uniform dispersive and distributive mixing of the batch material. Generally, one of the raker blade segments 54a, 54b and the trilobe kneading segments 50a, 50b is located at an end of the respective screw sets 38, 40 and adjacent the extrusion molding die 34, and downstream of the other of the raker blade segment 54a, 54b and the trilobe kneading segment 50a, 40b. In one example, each lobed kneading segment 50a, 50b can be located upstream of each raker blade segment 54a, 54b. In other words, the batch material can first be circumferentially mixed 60, and then axially mixed 64, before being extruded through the extrusion die 34. In a similar example, the radial mixing element 52a, 52b can be located between the lobed kneading segments 50a, 50b and the raker blade segments 54a, 54b. In other words, the batch material can first be circumferentially mixed 60, then radially mixed 62, and then axially mixed 64, before being extruded through the extrusion die 34.

In yet another example, generally arranged opposite the foregoing example, each lobed kneading segment 50a, 50b can be located downstream of each raker blade segment 54a, 54b. A radial mixing element 52a, 52b may or may not be located therebetween. Thus, the batch material can first be axially mixed 64, then radially mixed 62, and then circumferentially mixed 60 before being extruded through the extrusion die 34. In still yet other examples, the radial mixing element 52a, 52b can be located upstream or downstream of either of the kneading segment 50a, 50b and the raker blade segment 54a, 54b. Moreover, it is to be understood that various numbers of any or all of the segments 50, 52, 54 can be included. For example, a plurality of kneading segments 50a, 50b, raker blade segments 54a, 54b, and/or radial mixing elements 52a, 52b can be utilized and arranged variously at the discharge end 30 of the barrel 22. In addition or alternatively, it is to be understood that either or both of the screw sets 38, 40 may further include a tapered end segment 56a, 56b located at the furthest downstream position 30 (i.e., adjacent the extrusion die 34) so as to provide a generally continuous and directed flow of batch material towards the extrusion die 34.

An example method of using the twin-screw extruder 20 for manufacturing a ceramic honeycomb green body to produce a porous honeycomb filter will now be discussed. It is to be understood that more or less, similar or different method steps can also be included.

The method can include the step of providing the barrel 22 with the pair of chambers 24, 26 formed therein in communication with each other. The barrel 22 can also include the discharge port 36 and the extrusion molding die 34 coupled with respect to the discharge port 36 of the barrel 22. The method can further include the steps of providing the first screw set 38 rotatably mounted at least partially within one of the pair of chambers 24, and providing the second screw set 40 rotatably mounted at least partially within the other of the pair of chambers 26. The screw sets 38, 40 can be coupled to the driving mechanism 42 directly or indirectly, such as through drive shafts 46, 48.

The method can further include the step of providing a flowable ceramic batch material into the barrel 22, such as generally along the direction of arrow I of FIG. 1 via the material supply port 32 located generally towards an upstream side 28 of the barrel 22. The batch material can be supplied generally continuously. In addition or alternatively, a cooling medium, such as cooling water or the like, can be provided through the cooling structure coupled to the barrel 22 to cool the batch material in contact with the walls of the barrel 22. The screw sets 38, 40 can be further provided with pumping screw segments 44a, 44b for pumping the batch material towards the downstream side 30 of the barrel 22 generally along the direction of arrow II of FIG. 1.

The method can further include the step of mixing the ceramic batch material circumferentially 60 between the pair of chambers 24, 26 at the discharge port 36 of the barrel 22. For example, each of the first and second screw sets 38, 40 can be provided with a lobed kneading segment 50a, 50b for performing circumferential mixing 60 as discussed herein. Each lobed kneading element can be a trilobe segment that includes a triple-flight element 58.

The method can further include the step of mixing the ceramic batch material axially 64 within each of the pair of chambers 24, 26 at the discharge port 36 of the barrel 22. For example, each of the first and second screw sets 38, 40 can be provided with a raker blade segment 54a, 54b for performing the axial mixing 64 as discussed herein. Each raker blade segment can includes at least one flight element 70 (such as a bilobe, twin-flight arrangement) with a plurality of serrations 72 extending through each flight element 70. The method can further include the step of extruding the ceramic batch material through the extrusion die 34, such as generally along the direction of arrow III of FIG. 1, to produce the ceramic honeycomb green body.

In one example, the method steps can be arranged such that a quantity of the ceramic batch material is first mixed circumferentially 60, and then the quantity of the ceramic batch material is subsequently mixed axially 64 at the discharge port 36 of the barrel 22, and then the quantity of ceramic batch material is subsequently extruded through the extrusion die 34. Alternatively, the method steps can be arranged oppositely such that a quantity of the ceramic batch material is first mixed axially 64, and is subsequently mixed circumferentially 60, and then is subsequently extruded through the extrusion die 34.

In addition or alternatively, each of the first and second screw sets 38, 40 can be provided with a radial mixing element 52a, 52b for performing the radially mixing 62 of the batch material as discussed herein. For example, the radial mixing element 52a, 52b can mix a first, radially inward portion of the ceramic batch material with a second, radially outward portion of the ceramic batch material. The step of radially mixing of the batch material can be performed upstream or downstream of either of the circumferential mixing 60 and the axial mixing 64, and may even be performed as an intermediate step between the circumferential and axial mixing 60, 64.

It will be apparent to those skilled in the art that various modifications and variations can be made in the present invention without departing from the spirit or scope of the invention. Thus, it is intended that the present invention cover the modifications and variations of this invention provided they come within the scope of the appended claims.

What is claimed is:

1. A twin-screw extruder for extruding a ceramic or ceramic-forming material comprising:
a barrel including a pair of chambers formed therein in communication with each other and a discharge port;
an extrusion molding die coupled with respect to the discharge port of the barrel;
a first screw set rotatably mounted at least partially within one of the pair of chambers and including a first drive shaft;
a second screw set rotatably mounted in the other of the pair of chambers and including a second drive shaft generally parallel to the first drive shaft;
the first and second screw set each including a raker blade segment removably coupled to a respective one of the first and second drive shafts at the discharge port of the barrel, wherein each raker blade segment includes a double-flight element with a plurality of serrations extending through each of the flight elements;
the first and second screw set each further including a trilobe kneading segment removably coupled to a respective one of the first and second drive shafts at the discharge port of the barrel, the trilobe kneading segment including a triple-flight element; and
wherein one of the raker blade segment and the trilobe kneading segment is located at an end of the respective screw set and adjacent the extrusion molding die, and downstream of the other of the raker blade segment and the trilobe kneading segment.

2. The twin-screw extruder of claim 1, wherein the trilobe kneading segment is located upstream of the raker blade segment.

3. The twin-screw extruder of claim 1, wherein the first and second screw set each further includes a radial mixing element removably coupled to a respective one of the first and second drive shafts.

4. The twin-screw extruder of claim 3, wherein the radial mixing element is located between the raker blade segment and the trilobe kneading segment.

5. The twin-screw extruder of claim 1, wherein the flight elements of the trilobe kneading segment each include a pitch P equal to or greater than 3D, wherein D is an inner diameter of the chamber of the corresponding barrel.

6. The twin-screw extruder of claim 5, wherein the flight elements of the trilobe kneading segment each extend axially a distance equal to or less than P/4.

7. The twin-screw extruder of claim 1, wherein the trilobe kneading segment includes a plurality of positive pumping channels.

8. The twin-screw extruder of claim 7, wherein a first portion of the plurality of positive pumping channels extend into the trilobe kneading segment to a first depth, and wherein a second portion of the plurality of positive pumping channels extend into the trilobe kneading segment to a second depth.

9. The twin-screw extruder of claim 7, wherein the plurality of positive pumping channels are generally uniformly spaced about the trilobe kneading segment.

10. The twin-screw extruder of claim 1, wherein an area reduction ratio comparing a first area between a root of the flights of the trilobe kneading segment and the barrel wall, and a second area between a crest of the flights of the trilobe kneading segment and the barrel wall, is approximately two to one (2:1).

11. The twin-screw extruder of claim 1, wherein at least one of the plurality of serrations of each raker blade segment substantially extends to a root of the corresponding raker blade segment.

12. The twin-screw extruder of claim 1, wherein a surface roughness of at least one of the raker blade segment and the trilobe kneading segment is equal to or less than 2 micro-meter (Ra).

13. The twin-screw extruder of claim 12, wherein at least one of the raker blade segment and the trilobe kneading segment includes CPM-10V steel.

14. A twin-screw extruder, comprising:
a barrel including a pair of chambers formed therein in communication with each other and a discharge port;
an extrusion molding die coupled with respect to the discharge port of the barrel;
a first screw set rotatably mounted at least partially within one of the pair of chambers; and
a second screw set rotatably mounted at least partially within the other of the pair of chambers;
the first and second screw set each including a raker blade segment at the discharge port of the barrel, wherein each raker blade segment includes at least one flight element with a plurality of serrations extending through each flight element; and
the first and second screw set each further including a lobed kneading segment at the discharge port of the barrel, wherein each lobed kneading segment includes at least one flight element,
wherein each lobed kneading segment is located upstream from the corresponding raker blade segment.

15. The twin-screw extruder of claim 14, wherein the at least one flight element of the lobed kneading segment includes a pitch P equal to or greater than 3D, wherein D is an inner diameter of the chamber of the corresponding barrel.

16. The twin-screw extruder of claim 15, wherein the at least one flight element of the lobed kneading segment extends axially a distance equal to or less than P/4.

17. The twin-screw extruder of claim 14, wherein each lobed kneading segment has a pumping efficiency equal to or less than 10%.

18. The twin-screw extruder of claim 14, wherein each lobed kneading segment includes a triple-flight element.

19. The twin-screw extruder of claim 14, wherein each lobed kneading segment includes positive pumping channels.

20. The twin-screw extruder of claim 14, wherein at least one of the plurality of serrations of each raker blade segment substantially extends to a root of the corresponding raker blade segment.

21. The twin-screw extruder of claim 14, wherein the at least one flight element of each raker blade segment includes a double-flight element with a plurality of serrations extending through each of the flight elements.

22. The twin-screw extruder of claim 21, wherein each of the flight elements of each raker blade segment include a pitch equal to or greater than 0.5D, wherein D is an inner diameter of the chamber of the corresponding barrel.

23. The twin-screw extruder of claim 14, wherein a surface roughness of at least one of the raker blade segment and the lobed kneading segment is equal to or less than 2 micro-meter (Ra).

24. The twin-screw extruder of claim 23, wherein at least one of the raker blade segment and the trilobe kneading segment includes CPM-10V steel.

25. The twin-screw extruder of claim 14, wherein the first screw set includes a first drive shaft with the raker blade segment and the lobed kneading segment of the first screw set being removably coupled to the first drive shaft.

26. The twin screw extruder of claim 25, wherein the second screw set includes a second drive shaft with the raker blade segment and the lobed kneading segment of the second screw set being removably coupled to the second drive shaft, and wherein the first drive shaft is substantially parallel to the second drive shaft.

27. The twin-screw extruder of claim 14, wherein the first screw set and the second screw set each further includes a radial mixing element located between the corresponding raker blade segment and the corresponding lobed kneading segment.

28. A method of using a twin-screw extruder for preparing a batch material to produce an extruded thin-wall body, comprising the steps of:
providing a barrel including a pair of chambers formed therein in communication with each other, the barrel including a discharge port and an extrusion molding die coupled with respect to the discharge port of the barrel;
providing a first screw set rotatably mounted at least partially within one of the pair of chambers;
providing a second screw set rotatably mounted at least partially within the other of the pair of chambers;
providing a flowable ceramic batch material into the barrel;
mixing the ceramic batch material circumferentially between the pair of chambers at the discharge port of the barrel;
mixing the ceramic batch material axially within each of the pair of chambers at the discharge port of the barrel; and
extruding the ceramic batch material through the extrusion die to produce the ceramic honeycomb green body.

29. The method of claim 28, wherein a quantity of the ceramic batch material is mixed circumferentially at the discharge port of the barrel, and then the quantity of the ceramic batch material is subsequently mixed axially at the discharge port of the barrel, and then the quantity of ceramic batch material is subsequently extruded through the extrusion die.

30. The method of claim 28, further including the step of providing each of the first and second screw sets with a raker blade segment at the discharge port of the barrel for performing the step of mixing the ceramic batch material axially at the discharge port of the barrel, wherein each raker blade segment includes at least one flight element with a plurality of serrations extending through each flight element.

31. The method of claim 28, further including the step of providing each of the first and second screw sets with a trilobe kneading segment at the discharge port of the barrel, for performing the step of mixing the ceramic batch material circumferentially at the discharge port of the barrel, wherein each trilobe kneading element includes a triple-flight element.

32. The method of claim 28, further including the steps of:
providing each of the first and second screw sets with a radial mixing element; and
mixing the ceramic batch material with the radial mixing element to mix a first portion of the ceramic batch material with a second portion of the ceramic batch material, wherein the first portion of the ceramic batch material is radially located between a rotational axis of the radial mixing element and the second portion of the ceramic material.
